(19) United States
(12) Patent Application Publication
(10) Pub. No.: US 2026/0056093 A1
(43) Pub. Date: Feb. 26, 2026

(54) SAMPLING SYSTEM

(71) Applicant: Helia BioMonitoring B.V., Eindhoven (NL)

(72) Inventors: Rafiq Milan LUBKEN, Eindhoven (NL); Stijn Robert René HAENEN, Den Bosch (NL); Menno Willem José PRINS, Rosmalen (NL)

(73) Assignee: Helia BioMonitoring B.V., Eindhoven (NL)

(21) Appl. No.: 19/102,968

(22) PCT Filed: Aug. 4, 2023
(86) PCT No.: PCT/EP2023/071655

§ 371 Date: Feb. 11, 2025

(30) Foreign Application Priority Data
Aug. 31, 2022 (NL) 2032923

(51) Int. Cl. G01N 1/20

(52) U.S. Cl. CPC G01N 1/2035; G01N 2001/205

(57) ABSTRACT

A sampling system measures an analyte of interest present in a system of interest, wherein the analyte of interest is included in a medium, e.g., a fluid or another viscoelastic material. The sampling system includes a three-way junction, an inlet channel, an outlet channel, a measurement channel and a measurement chamber. A multiplexed sampling system includes two or more sampling systems. A method for measuring an analyte of interest present in a medium includes using the sample system.

The invention is related to a sampling system for measuring an analyte of interest present in a system of interest, wherein the analyte of interest is comprised in a medium, e.g., a fluid or another viscoelastic material. The invention is further related to a multiplexed sampling system and a method for measuring an analyte of interest present in a medium.

Systems of interest, such as biological systems, biotechnological systems, systems for the manufacturing or processing of pharmaceuticals and systems for the manufacturing or processing of feed and/or food, containing a medium comprising an analyte of interest may exhibit time dependencies due to dynamic changes in the system of interest, e.g., as a result of biological processes or fluctuating inputs. Time dependencies may manifest themselves as a changes, e.g., a concentration change of the analyte of interest in the medium present in the system of interest. Such changes of the analyte of interest may be indicative of the state of the system of interest. Measurement systems are used to measure the analyte of interest, e.g., a concentration of the analyte of interest in a medium that may be derived from or reflect the medium present in the system of interest. For example, measuring the analyte of interest allows to support research, patient monitoring, environmental monitoring, bioreactor monitoring, process monitoring, or applications of measurement-and-control.

The analyte of interest may be a chemical, biochemical, or biological substance or structure. The analyte of interest may be measured directly in the system of interest, e.g., the measurement system may be provided in a flow path of the medium in the system of interest. Alternatively, a serial process may be applied, e.g., the medium may be sampled from the system of interest and may be transported to another system of interest, for example, the system of interest may be an organism, an organ, a tissue, a vessel, a cell system, a unit operation, a reactor, a lumen, a line, a tube, a conduit, a bypass, a matrix with pores, a valve, a bag, a receptacle, a chip, a well plate, an intermediate container, a column, a reservoir, a hole, a channel, a chamber, a drip chamber.

The sample obtained from the system of interest may be pretreated, e.g., by filtration, dilution, dialysis, reagent addition, mixing, digestion, solvation, incubation, buffering, shearing, temperature treatment, radiation, illumination, acoustic excitation, extraction, separation, purification, coagulation, degassing, or by combinations thereof, before entering the sampling system. The sample from the system of interest may be pretreated and then transported to another system of interest, from which sample enters the sampling system. Additionally, the analyte of interest may be measured continuously, i.e., by taking non-discrete samples for measuring, or non-continuously, i.e., by taking discrete samples for measuring.

In the case of continuously measuring the analyte of interest, the medium with the analyte of interest may be transported continuously from the system of interest to the measurement system and measured thereby. A downside of this approach is that the measurement system requires a measurement time to measure the sample which may result here in a measurement with a low precision.

Using known sampling systems, transportation and measurement are performed sequentially. In a first step, a medium comprising the analyte of interest is transported from the system of interest to a measurement chamber. In a second step, the medium in the measurement chamber is measured. In these sampling systems, a measurement with a high time resolution may be obtained by using a short measurement time. This allows the second step to be shorter and thus to present a subsequent sample, of a subsequent first step, to the measurement chamber faster. However, a short measurement time may result in a measurement with a lower precision. To increase the precision of the measurement, a longer measurement time, and thus a longer second step, may be needed. This in turn may result in a measurement with a lower time resolution because there is a longer time between providing new samples to the measurement chamber.

For example, to achieve a higher time resolution and a higher precision, samples are collected using high flow rates. This reduces the transport time and thus reduces the time delay between sampling the analyte of interest and measuring the analyte of interest. In another example, to achieve a higher time resolution and a higher precision, immiscible fluid-fluid or fluid-gas interfaces are used between discrete packages of sample to decrease dispersion of the analyte of interest. However, these approaches may require large sample volumes, measurement techniques that are compatible with high flow rates, surface chemistries that are compatible with high flow rates, and may require complex fluidic systems to separate fluid-fluid or fluid-gas droplets, in order to prevent contamination of or interference with the measurement system or the sensing materials or the sensing surface.

It is an aim of the invention to provide an improved sampling system. It is a further aim of the invention to provide a sampling system that allows for a higher precision and a higher time resolution compared to known sampling systems.

The aim of the invention is achieved by a sampling system according to claim 1.

The sampling system of the invention is configured for measuring an analyte of interest present in a system of interest, wherein the analyte of interest is comprised in a medium, e.g., a fluid or another viscoelastic material, when the analyte of interest enters the sampling system. The analyte of interest may be one of the following: electrolyte, metabolite, small molecule, macromolecule, lipid, carbohydrate, peptide, hormone, drug, drug metabolite, protein, oligonucleotide, nucleic acid, DNA, RNA, (bio) organic substance, vesicle, nanoparticle, virus, virus-like particle, cell, cell fragment, cell-derived particle, or related substances, or parts thereof, or a combination thereof.

The measurement is performed by means of a measurement system of the sampling system, wherein the analyte of interest is measured using a signal, e.g., a signal from an object, such as a molecule, substance, particle, label, surface, or a combination thereof, related to the amount or concentration of the analyte of interest in the sample, for example by using energy transfer, resonance, scattering, absorption, motion, orientation, velocity, charge, current, redox effect, refractive index, fluorescence, luminescence, microscopic imaging, spectroscopy, multiplexed detection, change of conformation, enzymatic activity, color, or mass, or for example, Biosensing by Particle Motion wherein the binding of analyte of interest to specific binder molecules modulates the motion of particles.

The analyte of interest in the sampling system may be comprised in the same medium and in the same state as in the system of interest. In another example, the analyte of interest in the sampling system may be comprised in a medium that reflects or is derived from the medium in the system of interest. In another example, the analyte of interest may be in a state that reflects or is derived from the analyte in the system of interest. In these examples, the medium of the system of interest and/or the analyte of the system of interest may be pretreated, e.g., by modification, filtration, diluting, dialysis, reagent addition, grinding, mixing, digestion, solvation, incubation, buffering, shearing, temperature treatment, heating, cooling, illumination, acoustic excitation, centrifugation, purification, coagulation, pressure application, under- or over-pressure, chemical reaction, conversion, derivation, molecular lysis, cell lysis, enzymatic treatment, radiation treatment, amplification, separation, concentration, extraction, degassing, and the like, or by combinations thereof, before entering the sampling system.

For example, in cases wherein the medium and analyte of the sampling system are not pretreated, the medium and analyte of the system of interest may be the same as the medium and analyte of the sampling system. For example, a concentration in these cases may be inferred directly. For other examples, in cases wherein the medium and/or the analyte of the sampling system are pretreated, the pretreatment steps may have to be taken into account when determining a concentration in the system of interest via a measurement in the measurement chamber.

The analyte of interest has a concentration, the analyte concentration, in the medium in which it is present. The analyte concentration may be the concentration of the analyte in the medium in the system of interest or it may be the concentration of the analyte in the pretreated medium before it enters the sampling system. The concentration may be expressible for example as mass per mass (e.g., ppm, ppb), mass per volume (e.g., μg/mL, ng/mL, pg/mL) or mol per volume (e.g., μmol/L, nmol/L, pmol/L, fmol/L).

The sampling and measurement system may be provided with a functionality to provide wash steps, to add or release molecules or materials, to elute molecules or materials, or reset, reverse, regenerate or (re) activate the measurement system or the sensing materials or the sensing surface or parts thereof.

A system of interest may be a one of:
a potato processing factory/potato protein extraction factory, wherein the analyte of interest may be glycoalkaloids that are comprised in potato fruit juice;
a milk processing factory/milk protein extraction factory, wherein the analyte of interest may be lactoferrin which is comprised in milk;
an orange juice extraction factory/orange juice processing factory, wherein the analyte of interest may be limonin which is comprised in concentrated orange juice;
a unit operation or a bioreactor, for extraction, purification, or separation of bio-products, wherein the analyte of interest may be the intended product, an impurity, multiple products, multiple impurities, or combinations thereof;
a patient, wherein the analyte of interest may be inflammatory markers which are comprised in human blood plasma; and
a patient, wherein the analyte of interest may be pharmaceuticals/antibiotics which are comprised in human blood plasma.

The sampling system comprises a three-way junction that is connected to an inlet channel, an outlet channel, and a measurement channel. The inlet channel is connected or connectable to the system of interest to allow the medium comprising the analyte of interest to flow into the sampling system. For example, to allow the medium to be transported from the inlet channel, through the three-way junction, to the outlet channel. The measurement channel is provided between the three-way junction and a measurement chamber. The measurement channel provides a separation distance between the measurement chamber and the three-way junction, thus allowing for a delay of the exchange of medium, comprising the analyte of interest, between the three-way junction and the measurement chamber. This may allow, for example, for the presence of a sufficiently long secondary phase or for medium to flow in the primary phase without interacting with medium present in the measurement chamber.

In practice the measurement channel may be shorter than the inlet channel such that the measurement chamber is located closer to the three-way junction than the three-way junction is located to the system of interest.

The sampling system further comprises a measurement system for measuring the analyte of interest in the measurement chamber, e.g., to measure a concentration, a type, or a presence of the analyte of interest in the system of interest, e.g., by measuring an observable signal, such as an optical, fluorescent, chemiluminescent, bioluminescent, electrical, electrochemical, or a mechanical or mechanochemical signal, in a medium in the measurement chamber that is the same medium present in the system of interest, reflects, or is derived from the medium present in the system of interest.

The measurement chamber is further connected to a waste channel to allow medium with the analyte of interest to flow, e.g., after measuring, from the measurement chamber away from the sampling system, e.g., to be further measured, processed, collected or discarded.

The sampling system further comprises a medium transport system for causing a flow of medium from the inlet channel, through the three-way junction, to the outlet channel, and for causing a flow from the three-way junction, through the measurement channel and the measurement chamber, to the waste channel. In embodiments, the medium transport system may comprise a pump system and/or a valve system for causing the separate flows. The medium transport system may be configured to provide the flow of medium from the inlet channel, through the three-way junction, to the outlet channel independent of the flow of medium from the measurement channel, through the measurement chamber, to the waste channel. In embodiments, the medium transport system may cause the flow of medium from the inlet channel, through the three-way junction, to the outlet channel and simultaneously may cause the flow of medium from the three-way junction, through the measurement channel and the measurement chamber, to the waste channel. For example, the medium transport system may comprise one or more pumps and/or valves for causing the transport of medium using flow.

The sampling system further comprises a control system which is operatively connected to the measurement system and the medium transport system to control the measurement system and the medium transport system. The sampling system may comprise a processor programmed to operate the medium transport system according to the invention.

The control system is configured to operate the medium transport system to facilitate a primary phase for a duration of the primary phase, wherein the medium transport system is operated to cause a flow of medium from the inlet channel, through the three-way junction, to the outlet channel. During the primary phase, medium present in the three-way junction, e.g., a previously provided sample, is replaced with the sample taken from the system of interest, e.g., a newly provided sample.

The first effective characteristic time is a time required for the medium transport system to transport the sample, taken from the system of interest, from the system of interest to the three-way junction. The duration of the primary phase is longer than the first effective characteristic time of the sampling system. The first effective characteristic time is equivalently given to be a time required for the medium transport system to reduce a difference in analyte concentration between the three-way junction and the sample as taken from the system of interest, to below a predetermined value, e.g., to a concentration difference below 25%, preferably to below 10%, more preferably to below 5%, relative to the start of the primary phase, such that the sample present in the three-way junction at the end of the primary phase reflects the sample taken from the system of interest at the start of the primary phase. The effect of reducing the concentration difference to below the predetermined value relative to the start of the primary phase is that a sample may flow, due to the medium transport system, from the system of interest to the three-way junction. When the sample flows from the system of interest to the three-way junction, the relative concentration difference, i.e., the concentration difference between the system of interest at the time of sampling compared to the concentration at the three way junction, therebetween is reduced, so by reducing the concentration difference to below the predetermined value relative to the start of the primary phase, the sample of the system of interest may flow, due to the medium transport system, from the system of interest to the three-way junction.

The first effective characteristic time may be determined for a system of interest and a sampling system before using the sampling system. For example, the first effective characteristic time may be determined via a calibration for the sampling system properties and/or medium properties and/or properties of the system of interest. The first effective characteristic time may also be determined using a test setup of the sampling system or the first effective characteristic time may be determined analytically, e.g., based on sampling system properties, such as dimensions and flow rates, medium properties, such as viscosity and temperature, and properties of the system of interest, such as dimensions.

The first effective characteristic time, may be determined based on a sensitivity of the measurement system to the analyte in the medium and/or a required measurement throughput, i.e., an amount of measurements per hour. The first effective characteristic time, may further be determined based on an efficiency of the sampling system, medium transport system and/or measurement system.

Thus the medium transport system is configured to facilitate a primary phase which allows to provide a sample of the system of interest with analyte of interest in the three-way junction which has a concentration reflecting the analyte of interest in the medium of the system of interest as sampled. By continuing the flow of medium the sample in the three-way junction may continue to reflect the medium in the system of interest. The system of interest is continuously sampled in the primary phase, at least for as long as a sample of the system of interest needs to arrive at the three-way junction.

The control system is further configured to operate the medium transport system to facilitate a secondary phase for a duration of the secondary phase, independent of the primary phase. The measurement with the measurement system on the analyte of interest in the measurement chamber is performed during the secondary phase.

The duration of the secondary phase is shorter than a second effective characteristic time. The second effective characteristic time is a time within which a sample in the measurement chamber is substantially independent from a sample in the three-way junction. The second effective characteristic time may also be characterized as a time required to reduce, e.g., as a result of diffusion or an action of the medium transport system, a difference in analyte concentration between the three-way junction and the measurement chamber to a second predetermined value, e.g., to above 75%, preferably to above 85%, more preferably to above 95%, relative to the start of the secondary phase. During a time period lasting the duration of the secondary phase, the analyte concentration in the measurement chamber is significantly independent of the analyte concentration in the three-way junction. For example, during the secondary phase the sample in the measurement chamber is not disturbed due to diffusion and/or an action of the medium transport system. During the secondary phase a measurement may be performed on a sample in the measurement chamber, for example a sample that was previously transported in the primary and tertiary phases.

For example, the second effective characteristic time may be determined via a calibration for sampling system properties and/or medium properties and/or properties of the system of interest. The second effective characteristic time may also be determined using a test setup of the sampling system or the second effective characteristic time may be determined analytically, e.g., based on sampling system properties, such as dimensions and flow rates, medium properties, such as viscosity and temperature, and properties of the system of interest, such as dimensions.

The second effective characteristic time may be determined based on a sensitivity of the measurement system to the analyte in the medium and/or a required measurement throughput, i.e., an amount of measurements per hour. The second effective characteristic time may further be determined based on an efficiency of the sampling system, medium transport system and/or measurement system.

For example, an influence of a sample in the three-way junction on a sample in the measurement chamber, and thus a resulting reducing difference in concentration between the three-way junction and the measurement chamber, may be caused by the influence of advection and/or diffusion. By ensuring that the duration of the secondary phase is sufficiently short, e.g., depending on the dimensions of the measurement channel and the diffusion coefficient of the analyte of interest, the concentration difference is not reduced more than the second predetermined value during the second phase, which allows measuring the analyte of interest in the medium in the measurement chamber during the second phase. The analyte concentration in the secondary phase is substantially constant in at least the measurement chamber for the duration of the second effective characteristic time. The second effective characteristic time may be determined for a system of interest and a sampling system before using the sampling system. For example, requirements for precise measurements may put constraints on flow rates through the measurement chamber in the secondary phase, such as low flow conditions in the measurement chamber.

The control system is further configured to operate the medium transport system to facilitate a tertiary phase for a duration of the tertiary phase, wherein the medium transport system is operated to cause a flow of medium from the three-way junction, through the measurement channel and the measurement chamber, to the waste channel. During the tertiary phase, medium present in the measurement chamber, e.g., a previously provided sample, is replaced with medium present in at least the three-way junction, e.g., a newly provided sample. Thus the sample prepared or placed in the three-way junction may be transported to the measurement chamber once the measurement of the analyte of interest in the measurement chamber is complete.

The third effective characteristic time is a time required for the medium transport system to transport the sample from the three-way junction to the measurement chamber. The duration of the tertiary phase is longer than a third effective characteristic time. The third effective characteristic time is equivalently given to be a time required for the medium transport system in the tertiary phase to reduce a difference in analyte concentration between the three-way junction and the measurement chamber to a third predetermined value, e.g., to below 25%, preferably to below 10%, more preferably to below 5%, relative to the start of the tertiary phase, such that the sample present in the measurement chamber at the end of the tertiary phase reflects the sample that has been taken from the three-way junction at the start of the tertiary phase. The effect of reducing the concentration difference to below the predetermined value relative to the start of the tertiary phase is that a sample of the system of interest may flow, due to the medium transport system, from the three-way junction to the measurement chamber. When the sample flows from the three-way junction to the measurement chamber, the concentration difference is reduced, so by reducing the concentration difference to below the predetermined value relative to the start of the tertiary phase, the sample of the system of interest may flow, e.g., due to the medium transport system, from the three-way junction to the measurement chamber.

For example, the third effective characteristic time may be determined via a calibration for sampling system properties and/or medium properties and/or properties of the system of interest. The third effective characteristic time may also be determined using a test setup of the sampling system or the third effective characteristic time may be determined analytically, e.g., based on sampling system properties, such as dimensions and flow rates, medium properties, such as viscosity and temperature, and properties of the system of interest, such as dimensions.

The third effective characteristic time may be determined based on a sensitivity of the measurement system to the analyte in the medium and/or a required measurement throughput, i.e., an amount of measurements per hour desired. The third effective characteristic time may be further be determined based on an efficiency of the sampling system, medium transport system and/or measurement system.

Thus the medium transport system is configured to facilitate a tertiary phase which allows to provide a sample in the measurement chamber which has a concentration reflecting the sample in the three-way junction at the start of the tertiary phase. By continuing the flow of medium the sample in the measurement chamber may continue to reflect the medium in the system of interest.

Operating the medium transport system for at least the third effective characteristic time allows the medium transport system to transport the sample from the three-way junction to the measurement chamber, e.g., without damaging the measurement system.

The first, second and third effective characteristic times may be determined based on how long it takes for a concentration to change from a previous concentration to a desired concentration, or at least within a certain range, which is equivalent to movement of a sample through the corresponding components of the sampling system. This may be related to an amount of time it takes for a fluid, e.g., a fluid from a previous measurement cycle, to be replaced by a fluid from a current measurement cycle, which may depend on medium properties, sampling system properties, and/or and properties of the system of interest. The first, second and third predetermined values may be determined based on characteristics of the measurement system, e.g., the sensitivity thereof, the desired precision of the measurement, and/or amount of time a measurement cycle may take. For example, requiring that the third predetermined value is 5%, e.g., the concentration difference between the three-way junction and the measurement chamber is 5%, may allow for a precise and/or accurate measurement of the concentration of the analyte of interest in the system of interest, but at the same time it may take too long to reach.

During the secondary phase, the concentration of analyte of interest in medium present in the measurement chamber is mostly independent of concentration of analyte of interest in medium present in the three-way junction. This allows a sample for a subsequent measurement to be prepared in or placed in the three-way junction, i.e., the concentration of the analyte of interest in the three-way junction may become similar to the concentration in the system of interest, while a measurement on a sample is performed in the measurement chamber. Once the measurement is performed, the sample in the three-way junction may be transported to the measurement chamber in the tertiary phase to allow for a subsequent measurement of a subsequent sample.

The sampling system allows for a higher precision and a higher time resolution because the sampling system allows to prepare a subsequent sample in the three-way junction, i.e., during the primary phase, while performing a measurement in the measurement chamber on a sample, i.e., during an at least partially simultaneous secondary phase. Thus, sample transport and sample measurement may be performed in parallel, unlike with known systems wherein sample transport and sample measurement are performed in series. Thus, allowing an increased measurement time within the same total amount of time, which leads to an increase in precision, while simultaneously allowing higher flow rates and/or fluid-fluid or fluid-gas interfaces, to achieve short transport times from the system of interest to the three-way junction, which lead to a higher time resolution.

In embodiments, the medium transport system comprises:
a first pump system connected to the waste channel for providing a flow of medium in at least the waste channel; and
a first valve system provided between the measurement chamber and the first pump system and connecting the outlet channel to the waste channel, wherein, in a first position of the first valve system, the first valve system operatively connects the first pump system to the outlet channel and operatively disconnects the first pump system from the measurement chamber, and in a second position of the first valve system, the first valve system operatively disconnects the first pump system from the outlet channel and operatively connects the first pump system to the measurement chamber;
   wherein, in the primary phase, the first valve system is in the first position and the first pump system is operable by the control system to cause the flow of medium from the inlet channel, through the three-way junction and the outlet channel, to the waste channel, and wherein, in the tertiary phase, the first valve system is in the second position and the first pump system is operably by the control system to cause a flow of medium from the three-way junction, through the measurement channel and the measurement chamber, to the waste channel.

In these embodiments, the control system in is configurated to cause the medium transport system to facilitate the phases by using various configurations of a valve and a pump. These embodiments are particularly advantageous because only a single pump and a single valve are required. Other embodiments are possible as disclosed herein.

For example, when the first valve system operatively connects the outlet channel to the waste channel, the medium may flow from the outlet channel through the first valve system to the waste channel. When the first valve system operatively disconnects the outlet channel from the waste channel, the medium may not flow directly from the outlet channel through the first valve system to the waste channel.

In other embodiments, the medium transport system comprises:
a first pump system connected to the waste channel for providing a flow of medium from the three-way junction, through the measurement channel and the measurement chamber, to the waste channel; and
a second pump system connected to the outlet channel for providing a flow of medium from the inlet channel, through the three-way junction, to the outlet channel,
   wherein, in the primary phase, the second pump system is operably by the control system to cause the flow of medium from the inlet channel, through the three-way junction, to the outlet channel,
   and wherein, in the tertiary phase, the first pump system is operably by the control system to cause the flow of medium from the three-way junction, through the measurement channel and to the measurement chamber, to the waste channel.

These embodiments do not rely on the use of valves to allow facilitating of the phases, but rather on the use of two pump systems. The first pump system allows for the tertiary phase by causing the flow of medium from the three-way junction, through the measurement channel and the measurement chamber, to the waste channel, by being connected to the waste channel. Similarly, the second pump system allows for the primary phase by causing the flow of medium from the inlet channel, through the three-way junction, to the outlet channel by being connected to the outlet channel.

In embodiments, there is an open connection between the three-way junction and the measurement chamber. In these embodiments, the measurement channel is open, irrespective of the phase being facilitated by the sampling system. For example, in the first phase the medium may not flow through the measurement channel. However, this may be the result of the dimensions of the measurement channel, e.g., the length and width of the measurement channel, and not because the measurement channel is physically closed during the first phase.

In embodiments, the control system is configured such that the secondary phase at least partially overlaps with the primary phase and/or the tertiary phase at least partially overlaps with the primary phase. During the primary phase, a sample of the system of interest may be transported to the three-way junction by facilitating flow from the inlet channel, through the three-way junction, to the outlet channel. During the primary phase, a measurement performed in the secondary phase may be performed in the measurement chamber without the measurement being disturbed by a flow of medium. Thus by partially overlapping the primary phase with the secondary phase, the system is more efficient. Similarly by partially overlapping the primary phase and the tertiary phase the system may allow an increased measurement time within the same total amount of time, which leads to an increase in precision. When the first characteristic time is longer than the time required for performing a measurement, the tertiary phase may partially overlap with the primary phase once the measurement is performed to allow for faster transport of the subsequent sample to the measurement chamber.

In embodiments, a length of the measurement channel is greater than a characteristic diffusion distance, e.g., to more than 10%, preferably to more than 25%, more preferably to more than 50%, of \sqrt{TₘD}, wherein Tₘ is a measurement duration and D is a diffusion coefficient of the analyte of interest in the medium, e.g., wherein the measurement channel length is between 10 μm and 100 mm, preferably between 100 μm and 10 mm. In these embodiments, the length of the measurement channel is such that the analyte of interest may not effectively diffuse and/or flow through the measurement channel during the measurement time. For example, a subsequent sample may be prepared in or placed in the three-way junction, which subsequent sample may slowly propagate towards the measurement chamber under the effect of diffusion and/or flow. By choosing appropriate dimensions of the measurement channel, the measurement may be completed before the diffusion and/or flow may affect the sample in the measurement chamber during the secondary phase.

In embodiments, the sampling system is configured to have a flow of medium during the tertiary phase with a flow rate between 0.01 and 10,000 μL/min, preferably between 0.1 and 1000 μL/min and/or wherein the sampling system is configured to have a flow of medium in the three-way junction during the primary phase with a flow rate that is higher than the flow rate in the measurement chamber during the tertiary phase.

In embodiments, the sampling system is configured to have a low-flow condition during the secondary phase, in which low-flow condition the flow of medium from the three-way junction, through the measurement channel and the measurement chamber, to the waste channel is lower than the flow rate during the tertiary phase. The low-flow condition may be achieved by suitable dimensions of the measurement channel, or through an active flow stopping mechanism, e.g., such as a valve or a pump system preventing flow from the three-way junction, through the measurement channel and the measurement chamber, to the waste channel. Preferably, the flow rate of the low-flow condition through the measurement channel is three times, more preferably ten times, lower than the flow rate through the measurement channel during the tertiary phase. The low-flow condition may allow for favorable measurement conditions in the measurement chamber during the secondary phase.

In embodiments, a volume of the measurement chamber is between 0.1 and 1000 μL, preferably between 1 and 100 μL, and/or in these embodiments a cross-sectional area of the measurement channel is smaller than a cross-sectional area of the measurement chamber, e.g., wherein the cross-sectional area of the measurement channel is between 0.01 and 100 mm², preferably between 0.1 and 10 mm². A smaller cross-sectional area of the measurement channel allows for less passive flow, e.g., diffusive flow, through the measurement channel into the measurement chamber, thus allowing for a longer secondary phase. Further, a volume of the measurement chamber is an indicator of the required duration of the tertiary phase, since a larger volume requires a longer time to fill.

In embodiments, the sampling system is configured to, during the primary phase, transport a separation barrier through the inlet channel and/or the three-way junction, and/or the outlet channel, e.g., wherein the separation barrier is a gas bubble or a fluid droplet, which is preferably immiscible with the medium. Use of a separation barrier may allow for less dispersion of a subsequent sample and/or mixing with a current sample. For example, while a current sample is measured in the measurement chamber, a subsequent sample, separated from the current sample by a separation barrier may be prepared in or placed in the three-way junction. In these embodiments preferably a system is present to prevent the separation barrier from entering the measurement chamber, which may cause damage to the measurement chamber. The separation barrier may be a bubble or a fluid droplet with suitable characteristics, e.g., different from the medium.

In embodiments, the sampling system comprises a perturbation detector, e.g., provided in the inlet channel, which is configured to detect perturbations in the medium that are potentially harmful to the measurement chamber, and wherein the perturbation detector comprises means to divert the perturbation, e.g., to the outlet channel. For example, the perturbation detector may detect the separation barrier of the previous embodiments.

In embodiments, the sampling system comprises multiple measurement chambers connected in series and/or in parallel. For example, each measurement chamber has a different measurement system, allowing for measuring different characteristics of the analyte of interest, or different analytes of interest.

The invention is further related to a multiplexed sampling system comprising two or more sampling systems according to the invention, e.g., wherein the two or more sampling systems are connected in parallel, by connecting the outlet channel of a preceding sampling system to the inlet channel of a subsequent sampling system. For example, each sampling system of the multiplexed sampling system may comprise a measurement system suitable for measuring different characteristics of the analyte of interest and/or different analytes of interest in the same medium. Thus, the multiplexed sampling system allows for efficient measurements of multiple analytes of interest and/or various characteristics of an analyte of interest.

The invention further relates to a method for measuring an analyte of interest present in a system of interest, wherein the analyte of interest is comprised in a medium, e.g., a fluid or another viscoelastic material, wherein the analyte of interest has an analyte concentration in the medium and wherein use is made of a sampling system according to the invention, or a multiplexed sampling system according to the invention.

In embodiments of the method, the method comprises, when the inlet channel is connected to the system of interest:
operating the medium transport system to facilitate the primary phase for the duration of the primary phase, wherein the medium transport system is operated to cause the flow of medium from the inlet channel, through the three-way junction, to the outlet channel;
operating the medium transport system to facilitate the secondary phase for the duration of the secondary phase independent of the primary phase, wherein the measurement with the measurement system is performed on the analyte of interest present in the medium in the measurement chamber; and
operating the medium transport system to facilitate the tertiary phase for the duration of the tertiary phase, wherein the medium transport system is operated to cause the flow of medium from the three-way junction, through the measurement channel and the measurement chamber, to the waste channel
   wherein the duration of the primary phase is longer than the first effective characteristic time,
   wherein the duration of the secondary phase is shorter than the second effective characteristic time, and
   wherein the duration of the tertiary phase is longer than the third effective characteristic time.

For example, the secondary phase may, e.g., partially, overlap with the primary phase such that the measurement is performed during the primary phase. This may allow for a longer measurement time, while simultaneously allowing for a time efficient measurement cycle, because the subsequent sample is prepared while the measurement is performed.

In embodiments of the method, use is made of a sampling system at least according to claim 2, wherein the method comprises, when the inlet channel is connected to the system of interest:
operating the medium transport system to facilitate the primary phase for the duration of the primary phase, wherein the first valve system is in the first position and the first pump system is operated to transport the medium from the inlet channel, through the three-way junction, to the outlet channel;
operating the medium transport system to facilitate the secondary phase for the duration of the secondary phase and performing the measurement with the measurement system on medium present in the measurement chamber; and
operating the medium transport system to facilitate the tertiary phase for the duration of the tertiary phase, wherein the first valve system is in the second position and the first pump system is operated to transport the medium from the three-way junction, through the measurement channel and the measurement chamber, to the waste channel.

In embodiments of the method, use is made of a sampling system at least according to claim 3, wherein the method comprises, when the inlet channel is connected to the system of interest:
operating the medium transport system to facilitate the primary phase for the duration of the primary phase, wherein the second pump system is operated to transport the medium from the inlet channel, through the three-way junction, to the outlet channel;
operating the medium transport system to facilitate the secondary phase for the duration of the secondary phase and performing the measurement with the measurement system on medium present in the measurement chamber; and
operating the medium transport system to facilitate the tertiary phase for the duration of the tertiary phase, wherein the first pump system is operated to transport the medium from the three-way junction, through the measurement channel and the measurement chamber, to the waste channel.

The invention will be explained below with reference to the drawing, in which:

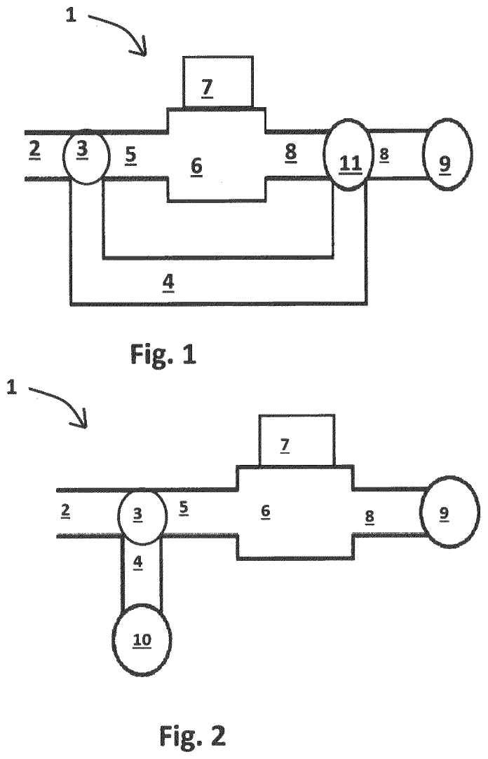

FIG. 1 schematically shows a first possible embodiment of the sampling system;

FIG. 2 schematically shows a second possible embodiment of the sampling system;

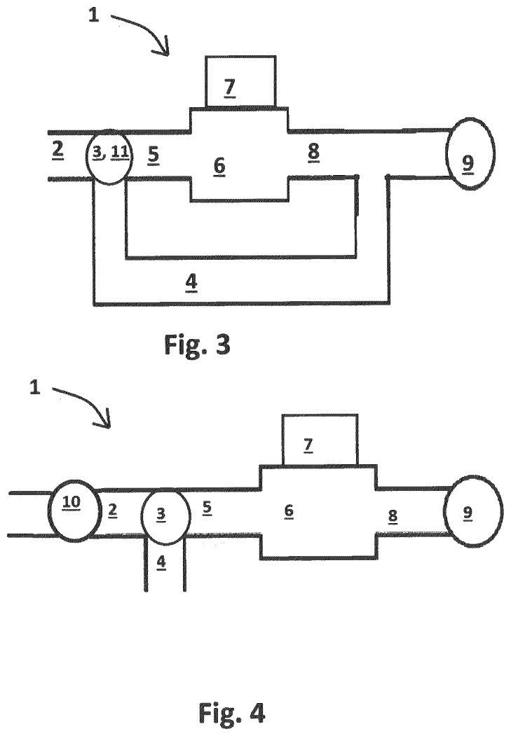

FIG. 3 schematically shows a third possible embodiment of the sampling system;

FIG. 4 schematically shows a fourth possible embodiment of the sampling system;

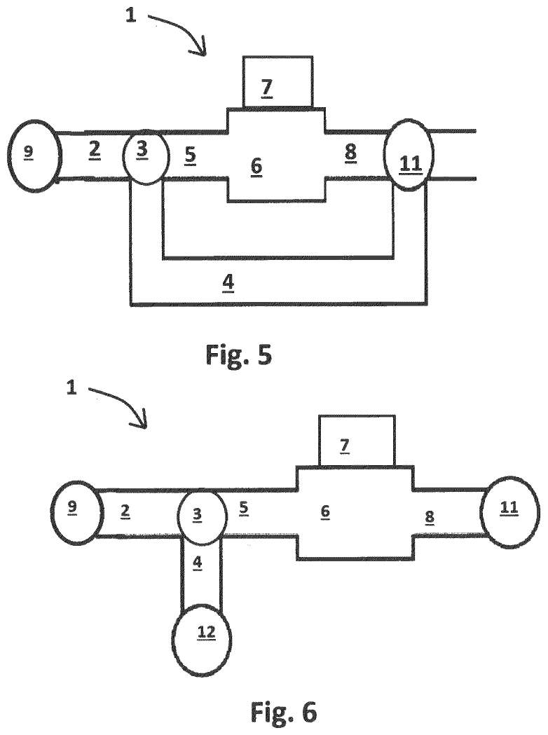

FIG. 5 schematically shows a fifth possible embodiment of the sampling system;

FIG. 6 schematically shows a sixth possible embodiment of the sampling system;

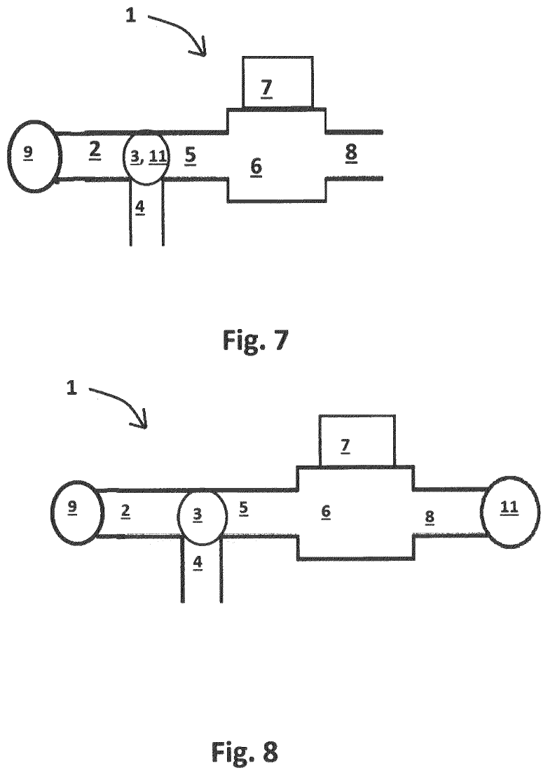

FIG. 7 schematically shows a seventh possible embodiment of the sampling system;

FIG. 8 schematically shows a eighth possible embodiment of the sampling system;

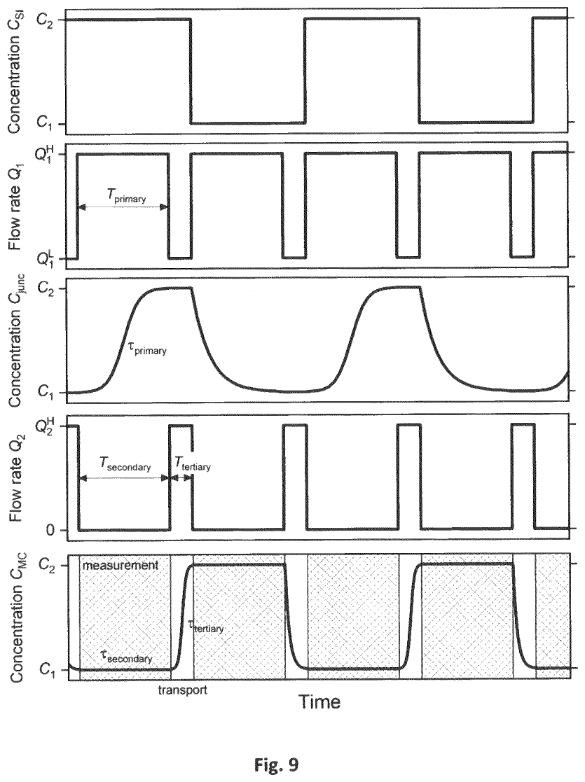

FIG. 9 shows a first example of concentration and flow rate profiles in a sampling system;

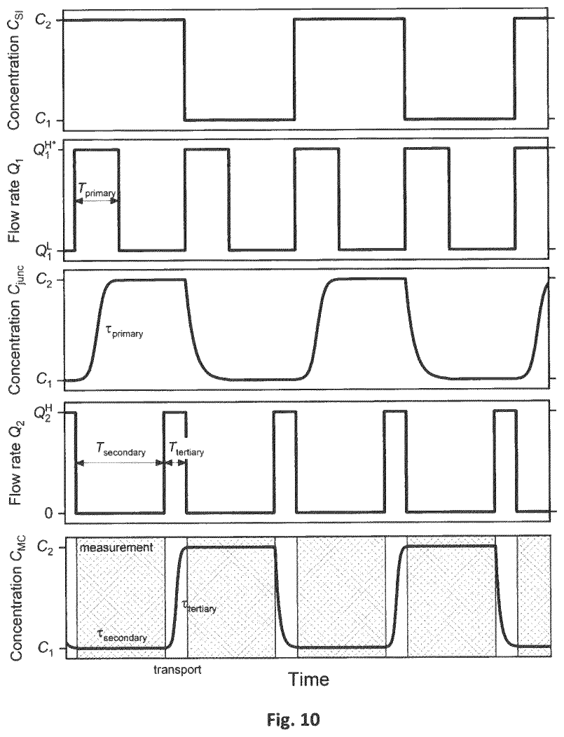

FIG. 10 shows a second example of concentration and flow rate profiles in a sampling system; and

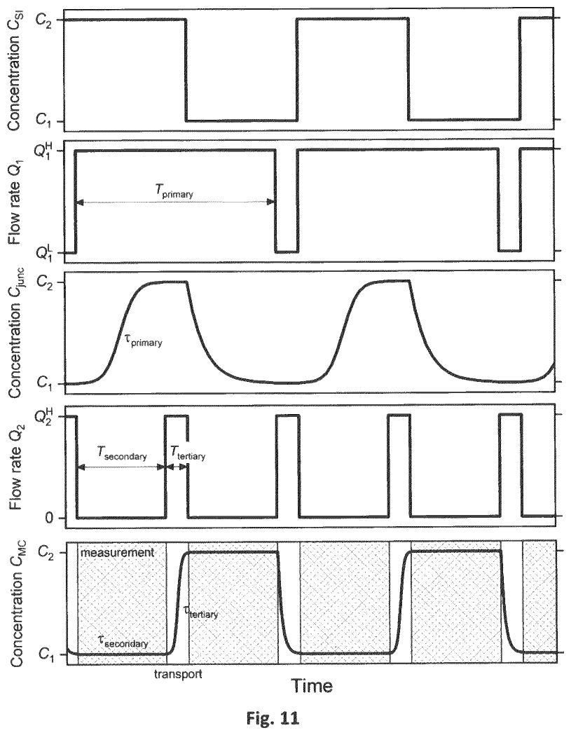

FIG. 11 shows a third example of concentration and flow rate profiles in a sampling system.

The following figures show possible embodiments of the sampling system 1, wherein use is made of valve systems and pump systems to allow for the various phases. In general, the sampling system 1 comprises an inlet channel 2, connected or connectable to a system of interest. The inlet channel 2 is connected to a three-way junction 3. The three-way junction 3 is further connected to an outlet channel 4 and a measurement channel 5. The measurement channel 5 is connected to a measurement chamber 6, wherein a measurement system 7 may measure the analyte of interest present in the medium in the measurement chamber 6. The measurement chamber 6 is further connected to a waste channel 8.

FIG. 1 schematically shows a first possible embodiment of the sampling system 1, wherein the medium transport system comprises:
a first pump system 9 connected to the waste channel 8 for providing a flow of medium from the three-way junction 3, through the measurement channel 5 and the measurement chamber 6, to the waste channel 8; and
a first valve system 11 provided between the measurement chamber 6 and the first pump system 9 and connecting the outlet channel 4 to the waste channel 8, wherein, in a first position of the first valve system 11, the first valve system 11 operatively connects the first pump system 9 to the outlet channel 4 and operatively disconnects the first pump system 9 from the measurement chamber 6, and in a second position of the first valve system 11 the first valve system 11 operatively disconnects the first pump system 9 from the outlet channel 4 and operatively connects the first pump system 9 to the measurement chamber 6;
   wherein, in the primary phase, the first valve system 11 is in the first position and the first pump system 9 is operably by the control system to cause the flow of medium from the inlet channel 2, through the three-way junction 3, to the outlet channel 4,
   and wherein, in the tertiary phase, the first valve system 11 is in the second position and the first pump system 9 is operably by the control system to cause a flow of medium from the three-way junction 3, through the measurement channel 5 and the measurement chamber 6, to the waste channel 8.

In this embodiment, the medium transport system is controllable by the control system to facilitate the phases by using various configurations of a first valve system 11 and a pump system 9. These embodiments are particularly advantageous because only a single pump system 9 and a single first valve system 11 are required. During the primary phase, direct flow of medium through the measurement channel 5 to the measurement chamber 6 may be prevented due to the presence of a previous sample, of medium and analyte of interest, present in the measurement chamber 6, which may not flow due to the position of the first valve system 11.

For example, when the first valve system 11 operatively connects the outlet channel 4 to the waste channel 8, the medium may flow from the outlet channel 4 through the first valve system 11 to the waste channel 8. When the first valve system 11 operatively disconnects the outlet channel 4 from the waste channel 8, the medium may not flow directly from the outlet channel 4 to the waste channel 8.

FIG. 2 schematically shows a second possible embodiment of the sampling system 1, wherein the medium transport system comprises:
a first pump system 9 connected to the waste channel 8 for providing a flow of medium from the three-way junction 3, through the measurement channel 5 and the measurement chamber 6, to the waste channel 8; and
a second pump system 10 connected to the outlet channel 4 for providing a flow of medium from the inlet channel 2, through the three-way junction 3, to the outlet channel 4,
   wherein, in the primary phase, the second pump system 10 is operable by the control system to cause the flow of medium from the inlet channel 2, through the three-way junction 3, to the outlet channel 4,
   and wherein, in the tertiary phase, the first pump system 9 is operable by the control system to cause the flow of medium from the three-way junction 3, through the measurement channel 5 and the measurement chamber 6, to the waste channel 8.

This embodiment does not rely on the use of valves to allow facilitating of the phases, but rather on the use of two pump systems. The first pump system 9 allows for the tertiary phase by causing the flow of medium from the three-way junction 3, through the measurement channel 5 and the measurement chamber 6, to the waste channel 8, by being connected to the waste channel 8. Similarly, the second pump system 10 allows for the primary phase by causing the flow of medium from the inlet channel 2, through the three-way junction 3, to the outlet channel 4, by being connected to the outlet channel 4.

FIG. 3 schematically shows a third possible embodiment of the sampling system 1, wherein the medium transport system comprises:
a first pump system 9 connected to the waste channel 8 for providing a flow of medium from the three-way junction 3, through the measurement channel 5 and the measurement chamber 6, to the waste channel 8; and
a first valve system 11 provided as part of the three-way junction 3 and connecting the inlet channel 2, to outlet channel 4 and to the measurement channel 5, wherein, in a first position of the first valve system 11, the first valve system 11 operatively connects the first pump system 9 to the outlet channel 4, and operatively disconnects the first pump system 9 from the measurement chamber 6, the waste channel 8 and the measurement channel 5, and in a second position of the first valve system 11 the first valve system 11 operatively disconnects the first pump system 9 from the outlet channel 4 and operatively connects the first pump system 9 to the waste channel 8, the measurement chamber 6, and the measurement channel 5;
   wherein, in the primary phase, the first valve system 11 is in the first position and the first pump system 9 is operable by the control system to cause the flow of medium from the inlet channel 2, through the three-way junction 3, to the outlet channel 4,
   and wherein, in the tertiary phase, the first valve system 11 is in the second position and the first pump system 9 is operated to cause a flow of medium from the three-way junction 3, through the measurement channel 5 and the measurement chamber 6, to the waste channel 8.

FIG. 4 schematically shows a fourth possible embodiment of the sampling system 1, wherein the medium transport system comprises:
a first pump system 9 connected to the waste channel 8 for providing a flow of medium from the three-way junction 3, through the measurement channel 5 and the measurement chamber 6, to the waste channel 8, or for preventing flow of medium from the three-way junction 4, through the measurement channel 5 and the measurement chamber 6, to the waste channel 8, e.g., by causing a flow in the measurement chamber 6 opposite direction and flow rate to a flow caused by the second pump system 10, or by closing the first pump system; and
a second pump system 10 connected to the inlet channel 2 for providing a flow of medium from the inlet channel 2, through the three-way junction 3, to the outlet channel 4 and, depending on the first pump system 9, simultaneously a flow from the inlet channel 2, through the three-way junction 3, the measurement channel 5 and the measurement chamber 6, to the waste channel 8,
   wherein, in the primary phase, the second pump system 10 is operable by the control system to cause the flow of medium from the inlet channel 2, through the three-way junction 3, to the outlet channel 4, and the first pump system 9 is operated to prevent a flow of medium from the three-way junction 3, through the measurement channel 5 and the measurement chamber 6, to the waste channel 8,
   and wherein, in the tertiary phase, the first pump system 9 and/or the second pump system 10 are operable by the control system to cause the flow of medium from the three-way junction 3, through the measurement channel 5 and the measurement chamber 6, to the waste channel 8.

FIG. 5 schematically shows a fifth possible embodiment of the sampling system 1, wherein the medium transport system comprises:
a first pump system 9 connected to the inlet channel 2 for providing a flow of medium in at least the inlet channel 2 and the three-way junction 3; and
a first valve system 11 provided in the waste channel 8 connecting the outlet channel 4 to the waste channel 8, wherein, in a first position of the first valve system 11, the first valve system 11 operatively connects the first pump system 9 to the outlet channel 4 and operatively disconnects the first pump system 9 from the measurement chamber 6, and in a second position of the first valve system 11 the first valve system 11 operatively disconnects the first pump system 9 from the outlet channel 4 and operatively connects the first pump system 9 to the measurement chamber 6;
   wherein, in the primary phase, the first valve system 11 is in the first position and the first pump system 9 is operable by the control system to cause the flow of medium from the inlet channel 2, through the three-way junction 3, to the outlet channel 4,
   and wherein, in the tertiary phase, the first valve system 11 is in the second position and the first pump system 9 is operable by the control system to cause a flow of medium from the three-way junction 3, through the measurement channel 5 and the measurement chamber 6, to the waste channel 8.

FIG. 6 schematically shows a sixth possible embodiment of the sampling system 1, wherein the medium transport system comprises:
a first pump system 9 connected to the inlet channel 2 for providing a flow of medium in at least the inlet channel 2 and the three-way junction 3; and
a first valve system 11 connected to the waste channel 8 wherein, in a first position of the first valve system 11, the first valve system 11 allows medium to flow from the three-way junction 3, through the measurement channel 5 and the measurement chamber 6, to the waste channel 8, and in a second position of the first valve system 11, the first valve system 11 prevents medium to flow from the three-way junction 3, through the measurement channel 5, and the measurement chamber 6, to the waste channel 8; and
a second valve system 12 connected to the outlet channel 4 wherein, in a first position of the second valve system 12, the second valve system 12 prevents medium to flow from the three-way junction 3, to the outlet channel, and in a second position of the second valve system 12, the second valve system 12 allows medium to flow from the three-way junction 3, to the outlet channel 4;
   wherein, in the primary phase, the first pump system 9 is operable by the control system, the first valve system 11 is in the second position, such that the flow of medium is prevented to flow from the three-way junction 3, through the measurement channel 5, and the measurement chamber 6, to the waste channel 8, and the second valve system 12 is in the second position, such that the flow of medium is caused to flow from the inlet channel 2, through the three-way junction 3, to the outlet channel 8,
   and wherein, in the tertiary phase, the first pump system 9 is operable by the control system and the first valve system 11 is in the first position, such that the flow of medium is caused to flow from the three-way junction 3, through the measurement channel 5 and the measurement chamber 6, to the outlet channel 8, and the second valve system 12 is in the first position, such that the flow of medium is prevented, or at least limited, to flow from the three-way junction 3, to the outlet channel 4.

FIG. 7 schematically shows a seventh possible embodiment of the sampling system 1, wherein the medium transport system comprises:
a first pump system 9 connected to the inlet channel 2 for providing a flow of medium in the inlet channel 2; and
a first valve system 11 provided as part of the three-way junction 3 and connecting the inlet channel 2, to outlet channel 4 and to the measurement channel 5, wherein, in a first position of the first valve system 11, the first valve system 11 operatively connects the first pump system 9 to the outlet channel 4, and operatively disconnects the first pump system 9 from the measurement chamber 6, the waste channel 8 and the measurement channel 5, and in a second position of the first valve system 11 the first valve system 11 operatively disconnects the first pump system 9 from the outlet channel 4 and operatively connects the first pump system 9 to the measurement chamber 6, the waste channel 8, and the measurement channel 5;
   wherein, in the primary phase, the first valve system 11 is in the first position and the first pump system 9 is operable by the control system to cause the flow of medium from the inlet channel 2, through the three-way junction 3, to the outlet channel 4,
   and wherein, in the tertiary phase, the first valve system 11 is in the second position and the first pump system 9 is operable by the control system to cause a flow of medium from the three-way junction 3, through the measurement channel 5 and the measurement chamber 6, to the waste channel 8.

FIG. 8 schematically shows an eighth possible embodiment of the sampling system 1, wherein the medium transport system comprises:
a first pump system 9 connected to the inlet channel 2 for providing a flow of medium in the inlet channel 2; and
a first valve system 11 connected to the waste channel 8 wherein, in a first position of the first valve system 11, the first valve system 11 allows medium to flow through the waste channel 8, and in a second position of the first valve system 11, the first valve system 11 prevents medium to flow through the waste channel 8,
   wherein, in the primary phase, the first pump system 9 is operable by the control system and the first valve system 11 is in the second position to allow the flow of medium from the inlet channel 2, through the three-way junction 3, to the outlet channel 4,
   and wherein, in the tertiary phase, the first pump system 9 is operable by the control system and the first valve system 12 is in the first position thereof to cause the flow of medium from the three-way junction 3, through the measurement channel 5 and the measurement chamber 6, to the waste channel 8.

FIG. 9 shows an example of concentration and flow rate profiles in a sampling system 1 during transport of a sample therethrough. The top graph of FIG. 9 shows an example of a concentration-time profile of the analyte in a system of interest (C_{SI}).

The second graph from the top of FIG. 9 shows a time profile of flow rate Q₁, i.e., the flow rate through the three-way junction 3 to the outlet channel 4. Here, Q₁ is used to transport a sample from the system of interest, through the three-way junction 3, to the outlet channel 4. For example, Q₁ modulates between values Q₁^{H} (H=high) and Q₁^{L} (L=low). Both high and low, for example zero, flow rates are allowed since these flow rates do not reach the measurement chamber, so do not affect sensor integrity and cannot damage the sensor.

The middle graph of FIG. 9 shows a concentration-time profile of analyte concentration C_{junc} in the three-way junction 3. To approach C_{junc}˜C_{SI}, and thus to reduce the difference in analyte concentration, the duration of the primary phase T_{primary} should be larger than the first effective characteristic time τ_{primary}. Since in this example Q₁^{H}>>Q_{MC}, wherein Q_{MC} is a maximum allowed flow rate in the measurement chamber 6, the first effective characteristic time τ_{primary}<<τ, wherein τ is representative of a characteristic time using the flow rate Q_{MC}. As a result, the total time in the primary phase T_{primary}<<Tₜᵣₐₙₛ the time in the transport phase. So the duration of the primary phase in sampling system 1 is much shorter than the duration of the transport phase in known sampling systems.

The fourth graph from the top of FIG. 1 shows a time profile of flow rate Q₂, i.e., the flow rate from the three-way junction 3 through the measurement chamber 6, to the waste channel 8, used to transport the sample fluid through the three-way junction 3 and through the measurement chamber 6. Q₂ is limited to Q₂^{H} which is determined by system properties such as the maximum allowed pressure and maximum allowed flow rate, e.g., to maintain sensor integrity and to preserve the sensor for long-term sensor use. The secondary phase has a duration T_{secondary}, and is a phase where limited sample exchange occurs between the three-way junction 3 and the measurement chamber 6.

The tertiary phase has duration T_{tertiary}, and is a phase where significant sample exchange occurs between the three-way junction 3 and the measurement chamber 6.

The bottom graph of FIG. 9 shows a concentration-time profile of concentration C_{MC} in the measurement chamber 6. The tertiary phase has a third effective characteristic time τ_{tertiary}. The tertiary phase is complete when the analyte concentration in the measurement chamber 6 approaches the value in the system of interest: C_{MC}˜C_{SI}. This is approached if T_{tertiary}>>τ_{tertiary}.

In the secondary phase, the exchange of sample between the measurement chamber 6 and the three-way junction 3 should generally be limited, in order to ensure a constant concentration during the secondary phase, i.e., T_{secondary}<<τ_{secondary}. τ_{secondary} is determined by, amongst others, geometrical parameters of the measurement system.

The measurement time fraction in the example equals

$$\frac{{T}_{secondary}}{{T}_{secondary} + {T}_{tertiary}} .$$

This fraction is close to unity, because T_{tertiary}<<T_{secondary}, which is advantageous for achieving good measurement results.

FIG. 10 shows a second example of concentration and flow rate profiles in a sampling system 1 during transport of a sample therethrough, wherein each graph shows similar information compared to FIG. 9. In FIG. 10, T_{primary}<T_{secondary}, with T_{primary}>>τ_{primary}. Here, τ_{primary} is shorter than in FIG. 9 due to different control system configurations and/or fluidic and/or geometrical parameters of the sampling system, for instance a higher flow rate

$$( i . e . , {Q}_{1}^{H *} > {Q}_{1}^{H} ) .$$

Therefore, T_{primary} can be set to a smaller value.

FIG. 11 shows a third example of concentration and flow rate profiles in a sampling system 1 during transport of a sample therethrough, wherein each graph shows similar information compared to FIGS. 9 and 10. In this example, T_{primary}>T_{secondary}, With T_{primary}>>τ_{primary}; furthermore, the characteristic frequency of the modulating concentration in the system of interest is much smaller than 1/τ_{primary}.

1. A sampling system for measuring an analyte of interest present in a system of interest, wherein the analyte of interest is comprised in a medium, and wherein the analyte of interest has an analyte concentration in the medium, wherein the sampling system comprises:
a three-way junction connected to an inlet channel, an outlet channel, and a measurement channel, wherein the measurement channel is provided between the three-way junction and a measurement chamber, and wherein the inlet channel is connected or connectable to the system of interest;
a measurement system for measuring the analyte of interest in the medium in the measurement chamber;
a waste channel connected to the measurement chamber;
a medium transport system for causing a flow of medium from the inlet channel, through the three-way junction, to the outlet channel, and for separately causing a flow of medium from the three-way junction, through the measurement channel and the measurement chamber, to the waste channel; and
a control system operatively connected to the measurement system and the medium transport system for controlling the measurement system and the medium transport system,
wherein the control system is configured to, when the inlet channel is connected to the system of interest:
operate the medium transport system to facilitate a primary phase for a duration of the primary phase, wherein the medium transport system is operated to cause a flow of medium from the inlet channel, through the three-way junction, to the outlet channel;
operate the medium transport system to facilitate a secondary phase for a duration of the secondary phase, independent of the primary phase, wherein the measurement system is operated to perform a measurement on the analyte of interest present in the medium in the measurement chamber; and
operate the medium transport system to facilitate a tertiary phase for a duration of the tertiary phase, wherein the medium transport system is operated to cause a flow of medium from the three-way junction, through the measurement channel and the measurement chamber, to the waste channel,
wherein the duration of the primary phase is longer than a first effective characteristic time which is a time required for the medium transport system in the primary phase to transport a sample of the system of interest, from the system of interest to the three-way junction,
wherein the duration of the secondary phase is shorter than a second effective characteristic time which is a time in which a sample in the measurement chamber is substantially independent from a sample in the three-way junction, and
wherein the duration of the tertiary phase is longer than a third effective characteristic time which is a time required for the medium transport system in the tertiary phase to transport a sample of the system of interest, from the three-way junction to the measurement chamber.

2. The sampling system according to claim 1, wherein the medium transport system comprises:
a first pump system connected to the waste channel for providing a flow of medium in at least the waste channel; and
a first valve system provided between the measurement chamber and the first pump system and connecting the outlet channel to the waste channel, wherein, in a first position of the first valve system, the first valve system operatively connects the first pump system to the outlet channel and operatively disconnects the first pump system from the measurement chamber, and in a second position of the first valve system, the first valve system operatively disconnects the first pump system from the outlet channel and operatively connects the first pump system to the measurement chamber;
wherein, in the primary phase, the first valve system is in the first position and the first pump system is operable by the control system to cause the flow of medium from the inlet channel, through the three-way junction and the outlet channel, to the waste channel,
and wherein, in the tertiary phase, the first valve system is in the second position and the first pump system is operable by the control system to cause a flow of medium from the three-way junction, through the measurement channel and the measurement chamber, to the waste channel.

3. The sampling system according to claim 1, wherein the medium transport system comprises:
a first pump system connected to the waste channel for providing a flow of medium from the three-way junction, through the measurement channel and the measurement chamber, to the waste channel; and
a second pump system connected to the outlet channel for providing a flow of medium from the inlet channel, through the three-way junction, to the outlet channel,
wherein, in the primary phase, the second pump system is operable by the control system to cause the flow of medium from the inlet channel, through the three-way junction, to the outlet channel,
and wherein, in the tertiary phase, the first pump system is operable by the control system to cause the flow of medium from the three-way junction, through the measurement channel and the measurement chamber, to the waste channel.

4. The sampling system according to claim 1, wherein there is an open connection between the three-way junction and the measurement chamber.

5. The sampling system according to claim 1, wherein the control system is configured such that the secondary phase at least partially overlaps with the primary phase and/or wherein the tertiary phase at least partially overlaps with the primary phase.

6. The sampling system according to claim 1, wherein a length of the measurement channel is greater than a characteristic diffusion distance of \sqrt{TₘD}, wherein Tₘ is a measurement duration and D is a diffusion coefficient of the analyte of interest in the medium.

7. The sampling system according to claim 1, wherein the sampling system is configured to have a flow of medium during the tertiary phase with a flow rate between 0.01 and 10,000 μL/min and/or wherein the sampling system is configured to have a flow of medium in the three-way junction during the primary phase with a flow rate that is higher than the flow rate during the tertiary phase in the measurement chamber.

8. The sampling system according to claim 1, wherein the sampling system is configured to have a low-flow condition during the secondary phase, in which low-flow condition the flow of medium from the three-way junction, through the measurement channel and the measurement chamber, to the waste channel, has a flow rate that is lower than the flow rate during the tertiary phase.

9. The sampling system according to claim 1, wherein a volume of the measurement chamber is between 0.1 and 1000 μL and/or wherein a cross-sectional area of the measurement channel is smaller than a cross-sectional area of the measurement chamber.

10. The sampling system according to claim 1, wherein the sampling system is configured to, during the primary phase, transport a separation barrier through the inlet channel and/or the outlet channel.

11. The sampling system according to claim 1, wherein the sampling system comprises a perturbation detector; which is configured to detect perturbations in the medium that are potentially harmful to the measurement chamber, and wherein the perturbation detector comprises means to divert the perturbation to the outlet channel.

12. A multiplexed sampling system comprising two or more sampling systems according to claim 1.

13. A method for measuring an analyte of interest present in a system of interest, wherein the analyte of interest is comprised in a medium and wherein the analyte of interest has an analyte concentration in the medium, wherein use is made of a sampling system comprising:
a three-way junction connected to an inlet channel, an outlet channel, and a measurement channel, wherein the measurement channel is provided between the three-way junction and a measurement chamber, and wherein the inlet channel is connected or connectable to the system of interest;
a measurement system for measuring the analyte of interest in the medium in the measurement chamber;
a waste channel connected to the measurement chamber;
a medium transport system for causing a flow of medium from the inlet channel, through the three-way junction, to the outlet channel, and for separately causing a flow of medium from the three-way junction, through the measurement channel and the measurement chamber, to the waste channel; and
a control system operatively connected to the measurement system and the medium transport system for controlling the measurement system and the medium transport system,
wherein the control system is configured to, when the inlet channel is connected to the system of interest;
operate the medium transport system to facilitate a primary phase for a duration of the primary phase, wherein the medium transport system is operated to cause a flow of medium from the inlet channel, through the three-way junction, to the outlet channel;
operate the medium transport system to facilitate a secondary phase for a duration of the secondary phase, independent of the primary phase, wherein the measurement system is operated to perform a measurement on the analyte of interest present in the medium in the measurement chamber; and
operate the medium transport system to facilitate a tertiary phase for a duration of the tertiary phase, wherein the medium transport system is operated to cause a flow of medium from the three-way junction, through the measurement channel and the measurement chamber, to the waste channel,
wherein the duration of the primary phase is longer than a first effective characteristic time which is a time required for the medium transport system in the primary phase to transport a sample of the system of interest, from the system of interest to the three-way junction,
wherein the duration of the secondary phase is shorter than a second effective characteristic time which is a time in which a sample in the measurement chamber is substantially independent from a sample in the three-way junction, and
wherein the duration of the tertiary phase is longer than a third effective characteristic time which is a time required for the medium transport system in the tertiary phase to transport a sample of the system of interest, from the three-way junction to the measurement chamber.

14. The method according to claim 13, wherein the method comprises, when the inlet channel is connected to the system of interest:
operating the medium transport system to facilitate the primary phase for the duration of the primary phase, wherein the medium transport system is operated to cause the flow of medium from the inlet channel, through the three-way junction to the outlet channel;
operating the medium transport system to facilitate the secondary phase for the duration of the secondary phase and independent of the primary phase, wherein the measurement with the measurement system is performed on the analyte of interest present in the medium in the measurement chamber; and
operating the medium transport system to facilitate the tertiary phase for the duration of the tertiary phase, wherein the medium transport system is operated to cause the flow of medium from the three-way junction, through the measurement channel and the measurement chamber, to the waste channel,
wherein the duration of the primary phase is longer than the first effective characteristic time,
wherein the duration of the secondary phase is shorter than the second effective characteristic time, and
wherein the duration of the tertiary phase is longer than the third effective characteristic time.

15. The method according to claim 13, wherein the medium transport system comprises:
a first pump system connected to the waste channel for providing a flow of medium in at least the waste channel; and
a first valve system provided between the measurement chamber and the first pump system and connecting the outlet channel to the waste channel, wherein, in a first position of the first valve system, the first valve system operatively connects the first pump system to the outlet channel and operatively disconnects the first pump system from the measurement chamber, and in a second position of the first valve system, the first valve system operatively disconnects the first pump system from the outlet channel and operatively connects the first pump system to the measurement chamber;
wherein, in the primary phase, the first valve system is in the first position and the first pump system is operable by the control system to cause the flow of medium from the inlet channel, through the three-way junction and the outlet channel, to the waste channel,
and wherein, in the tertiary phase, the first valve system is in the second position and the first pump system is operable by the control system to cause a flow of medium from the three-way junction, through the measurement channel and the measurement chamber, to the waste channel,
wherein the method comprises, when the inlet channel is connected to the system of interest:
operating the medium transport system to facilitate the primary phase for the duration of the primary phase, wherein the first valve system is in the first position and the first pump system is operated to transport the medium from the inlet channel, through the three-way junction, to the outlet channel;
operating the medium transport system to facilitate the secondary phase for the duration of the secondary phase and performing the measurement with the measurement system on medium present in the measurement chamber; and
operating the medium transport system to facilitate the tertiary phase for the duration of the tertiary phase, wherein the first valve system is in the second position and the first pump system is operated to transport the medium from the three-way junction, through the measurement channel and the measurement chamber, to the waste channel,
wherein the duration of the primary phase is longer than the first effective characteristic time,
wherein the duration of the secondary phase is shorter than the second effective characteristic time, and
wherein the duration of the tertiary phase is longer than the third effective characteristic time.

16. The method according to claim 13, wherein the medium transport system comprises:
a first pump system connected to the waste channel for providing a flow of medium from the three-way junction, through the measurement channel and the measurement chamber, to the waste channel; and
a second pump system connected to the outlet channel for providing a flow of medium from the inlet channel, through the three-way junction, to the outlet channel,
wherein, in the primary phase, the second pump system is operable by the control system to cause the flow of medium from the inlet channel, through the three-way junction, to the outlet channel,
and wherein, in the tertiary phase, the first pump system is operable by the control system to cause the flow of medium from the three-way junction, through the measurement channel and the measurement chamber, to the waste channel,
wherein the method comprises, when the inlet channel is connected to the system of interest:
operating the medium transport system to facilitate the primary phase for the duration of the primary phase, wherein the second pump system is operated to transport the medium from the inlet channel, through the three-way junction, to the outlet channel;
operating the medium transport system to facilitate the secondary phase for the duration of the secondary phase and performing the measurement with the measurement system on medium present in the measurement chamber; and
operating the medium transport system to facilitate the tertiary phase for the duration of the tertiary phase, wherein the first pump system is operated to transport the medium from the three-way junction, through the measurement channel and the measurement chamber, to the waste channel,
wherein the duration of the primary phase is longer than the first effective characteristic time,
wherein the duration of the secondary phase is shorter than the second effective characteristic time, and
wherein the duration of the tertiary phase is longer than the third effective characteristic time.
